(19) United States
(12) Patent Application Publication
(10) Pub. No.: US 2025/0317783 A1
(43) Pub. Date: Oct. 9, 2025

(54) COORDINATION OF TERMINAL-INITIATED REPORTING

(71) Applicant: Nokia Technologies Oy, Espoo (FI)

(72) Inventors: Timo KOSKELA, Oulu (FI); Juha Pekka KARJALAINEN, Oulu (FI); Sami-Jukka HAKOLA, Oulu (FI)

(21) Appl. No.: 19/169,353

(22) Filed: Apr. 3, 2025

(30) Foreign Application Priority Data
Apr. 4, 2024 (GB) 2404788.8

(51) Int. Cl. H04W 24/10

(52) U.S. Cl. CPC H04W 24/10

(57) ABSTRACT

There are provided measures for coordination of terminal-initiated reporting. Such measures exemplarily comprise performing measurements on at least one reference signal, determining, based on a result of the performing measurements, whether a reporting condition is fulfilled, transmitting, when the reporting condition is fulfilled, a notification indicative of an intention to transmit a radio condition report, determining, when the reporting condition is fulfilled, based on at least one configured reporting parameter, reporting occasion resources out of a sequence of reporting occasion resources as reporting resources to be used for transmission of the radio condition report, generating the radio condition report based on the result of the performing measurements, and transmitting, when the reporting condition is fulfilled, the radio condition report in the reporting resources to be used for transmission of the radio condition report.

### RELATED APPLICATIONS

This application claims priority to United Kingdom patent application No. 2404788.8, filed Apr. 4, 2024, entitled “COORDINATION OF TERMINAL-INITIATED REPORTING” which is hereby incorporated by reference in its entirety.

### FIELD

Various example embodiments relate to coordination of terminal-initiated reporting. More specifically, various example embodiments exemplarily relate to measures (including methods, apparatuses and computer program products) for realizing coordination of terminal-initiated reporting.

### BACKGROUND

The present specification generally relates to reporting related to radio conditions experienced by terminals, mobile stations, modems, or user equipments (UE), such as a smartphone, and the like.

Such reporting may for example be channel state information (CSI) reporting, layer 1 reporting, beam reporting, and the like.

Such reporting may for example relate to multiple input multiple output (MIMO)/beam management (BM).

Such reporting may be periodic reporting, were a terminal (always) repeatedly measures a reference signal and periodically reports in predetermined periodic radio resources irrespective of whether reporting was actually necessary (i.e., irrespective of whether there are e.g., changes in a radio condition experienced), aperiodic reporting, where a terminal, once it is triggered to report, measures a reference signal and reports once, and semi-persistent reporting, where a terminal, once it is triggered to report, repeatedly measures a reference signal and periodically reports in predetermined periodic radio resources until it is released from reporting (i.e., semi-persistent reporting is a kind of mix of periodic and aperiodic reporting).

On the other hand, such reporting may be terminal-initiated, e.g., event-driven, where the event may be detection of a predetermined condition.

For such terminal-initiated reporting, the terminal must be provided/scheduled with resources enabling the terminal to actually transmit the data to be reported.

Such resource scheduling is accompanied with management overhead, resource waste, and communication latency, as both parties involved in the reporting, the terminal and a network node providing access to a network must be aware of the resources (to be) used by the terminal for the reporting.

Hence, the problem arises that e.g., management overhead, resource waste, and communication latency are detrimental to operation of a mobile network both for the involved terminal itself but also for the overall network and affected other terminals.

Hence, there is a need to provide for coordination of terminal-initiated reporting.

### SUMMARY

Various example embodiments aim at addressing at least part of the above issues and/or problems and drawbacks.

Various aspects of example embodiments are set out in the appended claims.

According to an exemplary aspect, there is provided an apparatus, comprising means for transmitting a notification indicative of an intention to transmit a radio condition report, means for determining, based on at least one configured reporting parameter, reporting occasion resources out of a sequence of reporting occasion resources as reporting resources to be used for transmission of said radio condition report, and means for transmitting said radio condition report in said reporting resources to be used for transmission of said radio condition report, wherein said at least one configured reporting parameter is indicative of a relationship between notification occasion resources utilized for said notification and said reporting resources to be used for transmission of said radio condition report.

According to an exemplary aspect, there is provided an apparatus, comprising at least one processor, and at least one memory storing instructions that, when executed by the at least one processor, cause the apparatus at least to perform transmitting a notification indicative of an intention to transmit a radio condition report, determining, based on at least one configured reporting parameter, reporting occasion resources out of a sequence of reporting occasion resources as reporting resources to be used for transmission of said radio condition report, and transmitting said radio condition report in said reporting resources to be used for transmission of said radio condition report, wherein said at least one configured reporting parameter is indicative of a relationship between notification occasion resources utilized for said notification and said reporting resources to be used for transmission of said radio condition report.

According to an exemplary aspect, there is provided a method, comprising transmitting a notification indicative of an intention to transmit a radio condition report, determining, based on at least one configured reporting parameter, reporting occasion resources out of a sequence of reporting occasion resources as reporting resources to be used for transmission of said radio condition report, and transmitting said radio condition report in said reporting resources to be used for transmission of said radio condition report, wherein said at least one configured reporting parameter is indicative of a relationship between notification occasion resources utilized for said notification and said reporting resources to be used for transmission of said radio condition report.

According to an exemplary aspect, there is provided an apparatus, comprising means for performing measurements on at least one reference signal, means for determining, based on a result of said means for performing measurements, whether a reporting condition is fulfilled, means for transmitting, when said reporting condition is fulfilled, a notification indicative of an intention to transmit a radio condition report, means for determining, when said reporting condition is fulfilled, based on at least one configured reporting parameter, reporting occasion resources out of a sequence of reporting occasion resources as reporting resources to be used for transmission of said radio condition report, means for generating said radio condition report based on said result of said means for performing measurements, and means for transmitting, when said reporting condition is fulfilled, said radio condition report in said reporting resources to be used for transmission of said radio condition report.

According to an exemplary aspect, there is provided an apparatus, comprising at least one processor, and at least one memory storing instructions that, when executed by the at least one processor, cause the apparatus at least to perform performing measurements on at least one reference signal, determining, based on a result of said performing measurements, whether a reporting condition is fulfilled, transmitting, when said reporting condition is fulfilled, a notification indicative of an intention to transmit a radio condition report, determining, when said reporting condition is fulfilled, based on at least one configured reporting parameter, reporting occasion resources out of a sequence of reporting occasion resources as reporting resources to be used for transmission of said radio condition report, generating said radio condition report based on said result of said performing measurements, and transmitting, when said reporting condition is fulfilled, said radio condition report in said reporting resources to be used for transmission of said radio condition report.

According to an exemplary aspect, there is provided a method, comprising performing measurements on at least one reference signal, determining, based on a result of said performing measurements, whether a reporting condition is fulfilled, transmitting, when said reporting condition is fulfilled, a notification indicative of an intention to transmit a radio condition report, determining, when said reporting condition is fulfilled, based on at least one configured reporting parameter, reporting occasion resources out of a sequence of reporting occasion resources as reporting resources to be used for transmission of said radio condition report, generating said radio condition report based on said result of said performing measurements, and transmitting, when said reporting condition is fulfilled, said radio condition report in said reporting resources to be used for transmission of said radio condition report.

According to an exemplary aspect, there is provided an apparatus, comprising means for receiving a notification indicative of an intention to transmit a radio condition report, means for determining, based on at least one configured reporting parameter, reporting occasion resources out of a sequence of reporting occasion resources as reporting resources expected to be used for transmission of said radio condition report, and means for monitoring for said radio condition report in said reporting resources expected to be used for transmission of said radio condition report.

According to an exemplary aspect, there is provided an apparatus, comprising at least one processor, and at least one memory storing instructions that, when executed by the at least one processor, cause the apparatus at least to perform receiving a notification indicative of an intention to transmit a radio condition report, determining, based on at least one configured reporting parameter, reporting occasion resources out of a sequence of reporting occasion resources as reporting resources expected to be used for transmission of said radio condition report, and monitoring for said radio condition report in said reporting resources expected to be used for transmission of said radio condition report.

According to an exemplary aspect, there is provided a method, comprising receiving a notification indicative of an intention to transmit a radio condition report, determining, based on at least one configured reporting parameter, reporting occasion resources out of a sequence of reporting occasion resources as reporting resources expected to be used for transmission of said radio condition report, and monitoring for said radio condition report in said reporting resources expected to be used for transmission of said radio condition report.

According to an exemplary aspect, there is provided a computer program product comprising computer-executable computer program code which, when the program is run on a computer (e.g., a computer of an apparatus according to any one of the aforementioned apparatus-related exemplary aspects of the present disclosure), is configured to cause the computer to carry out the method according to any one of the aforementioned method-related exemplary aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient information derivation and/or exchange regarding the resources (to be) used by the terminal for the reporting to thereby solve at least part of the problems and drawbacks identified in relation to the prior art.

By way of example embodiments, there is provided coordination of terminal-initiated reporting. More specifically, by way of example embodiments, there are provided measures and mechanisms for realizing coordination of terminal-initiated reporting.

Thus, improvement is achieved by methods, apparatuses and computer program products enabling/realizing coordination of terminal-initiated reporting.

### BRIEF DESCRIPTION OF THE DRAWINGS

In the following, the present disclosure will be described in greater detail by way of non-limiting examples with reference to the accompanying drawings, in which

FIG. 1 is a block diagram illustrating an apparatus according to example embodiments,

FIG. 2 is a block diagram illustrating an apparatus according to example embodiments,

FIG. 3 is a block diagram illustrating an apparatus according to example embodiments,

FIG. 4 is a block diagram illustrating an apparatus according to example embodiments,

FIG. 5 is a block diagram illustrating an apparatus according to example embodiments,

FIG. 6 is a schematic diagram of a procedure according to example embodiments,

FIG. 7 is a schematic diagram of a procedure according to example embodiments,

FIG. 8 is a schematic diagram of a procedure according to example embodiments,

FIG. 9 shows a schematic diagram illustrating relationships between uplink resources according to example embodiments,

FIG. 10 shows a schematic diagram illustrating relationships between uplink resources and possible resource selection results according to example embodiments,

FIG. 11 shows a schematic diagram illustrating relationships between uplink resources and possible resource selection results according to example embodiments,

FIG. 12 shows a schematic diagram illustrating relationships between uplink resources and possible resource selection results according to example embodiments,

FIG. 13 shows a schematic diagram illustrating relationships between uplink resources and possible resource selection results according to example embodiments, and

FIG. 14 is a block diagram alternatively illustrating apparatuses according to example embodiments.

### DETAILED DESCRIPTION

The present disclosure is described herein with reference to particular non-limiting examples and to what are presently considered to be conceivable embodiments. A person skilled in the art will appreciate that the disclosure is by no means limited to these examples, and may be more broadly applied.

It is to be noted that the following description of the present disclosure and its embodiments mainly refers to specifications being used as non-limiting examples for certain exemplary network configurations and deployments. Namely, the present disclosure and its embodiments are mainly described in relation to 3GPP specifications being used as non-limiting examples for certain exemplary network configurations and deployments. As such, the description of example embodiments given herein specifically refers to terminology which is directly related thereto. Such terminology is only used in the context of the presented non-limiting examples, and does naturally not limit the disclosure in any way. Rather, any other communication or communication related system deployment, etc. may also be utilized as long as compliant with the features described herein.

Hereinafter, various embodiments and implementations of the present disclosure and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

According to example embodiments, in general terms, there are provided measures and mechanisms for (enabling/realizing) coordination of terminal-initiated reporting.

Terminal-initiated reporting (or UE-initiated reporting or UE event driven reporting) provides advantages regarding resource utilization and configuration flexibility.

One example application of terminal-initiated reporting (or UE-initiated reporting or UE event driven reporting) is UE-initiated/event-driven beam management (MIMO/BM).

Advantageously, control thereof is facilitated leveraging (as much as possible) 3^{rd} Generation Partnership Project (3GPP) legacy CSI measurement and reporting configuration frameworks, targeting frequency range 2 (FR2) and single transmission/reception point (sTRP) with intra-and inter-cell beam management.

Furthermore, one of the objectives of 3GPP NR Rel-release 19 mobility enhancements is to specify necessary components to support event triggered layer 1 (L1) measurement reporting (such as CSI reporting but not limited to it) for L1/L2 triggered mobility (LTM), which may be L1/L2 centric mobility, lower layer triggered mobility, L2 mobility.

Heretofore, uplink (UL) signaling content(s) (and procedure(s) as required) for UE-initiated/event-driven beam reporting facilitating fast beam switching and also UL signaling medium/container considering the UE-initiated/event-driven nature of the UL transmission, designed primarily for the purpose of beam reporting, are to be defined.

In this regard, in relation to MIMO/BM the following is conceivable:

For terminal-initiated reporting (or UE-initiated reporting or UE event driven reporting), a terminal/UE has to detect a trigger-event for beam reporting. In view thereof, the terminal/UE may monitor a reference signal (RS) (or a plurality of RSs) to assess if a beam-reporting trigger condition has been met.

Further, for terminal-initiated reporting (or UE-initiated reporting or UE event driven reporting), a terminal/UE has to transmit a beam-report, with the content of the beam report being indicative of the experienced radio condition, and with the signaling medium/container for beam report transmission being, for example, a medium access control control element (MAC-CE) or uplink control information (UCI).

UE-initiated/event-driven beam reporting may be implemented utilizing a concept according to which the UE requests UL resource(s) for the beam report (and the network grants/schedules such UL resource(s)), a concept according to which a UE notifies beforehand transmission of a beam report, and a concept where the network (e.g., a gNB preconfigures UL resources for the UE's beam report).

As discussed above, reporting may be performed using periodic reporting, aperiodic reporting, and semi-persistent reporting.

These concepts are explained below with reference to layer 1 (L1) reference signal received power (RSRP) reporting according to a CSI framework.

As mentioned, such frameworks may be leveraged/utilized as much as possible also for terminal-initiated reporting (or UE-initiated reporting or UE event driven reporting). Leverage/utilization thereof as much as possible may be aimed for.

According to this framework, procedures on aperiodic CSI reporting assume that the CSI reporting is triggered by DCI format 0_1, but they equally apply to CSI reporting triggered by DCI format 0_2, by applying higher layer parameter reportTriggerSizeDCI-0-2 instead of reportTriggerSize. Procedures on aperiodic CSI reporting further assume that the CSI reporting is triggered by DCI format 0_1, but they equally apply to CSI reporting triggered by DCI format 0_3.

According to this framework, further, the time and frequency resources that can be used by the UE to report CSI are controlled by the gNB. CSI may consist of channel quality indicator (CQI), precoding matrix indicator (PMI), CSI-RS resource indicator (CRI), SS/PBCH block resource indicator (SSBRI), layer indicator (LI), rank indicator (RI), L1-RSRP, L1-SINR, CapabilityIndex or time-domain channel properties (TDCP).

According to this framework, further, each reporting setting CSI-ReportConfig is associated with a single downlink bandwidth part (BWP) (indicated by higher layer parameter BWP-Id) given in the associated CSI-ResourceConfig for channel measurement and contains the parameter(s) for one CSI reporting band: codebook configuration including codebook subset restriction, time-domain behavior, frequency granularity for CQI and PMI, measurement restriction configurations, and the CSI-related quantities to be reported by the UE such as the LI, L1-RSRP, L1-SINR, CRI, SSBRI, CapabilityIndex and TDCP.

According to this framework, further, the time domain behavior of the CSI-ReportConfig is indicated by the higher layer parameter reportConfigType and can be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset applies in the numerology of the UL BWP in which the CSI report is configured to be transmitted on. The higher layer parameter reportQuantity indicates the CSI-related, L1-RSRP-related, L1-SINR-related, CapabilityIndex-related or TDCP-related quantities to report.

According to this framework, further, each CSI resource setting CSI-ResourceConfig contains a configuration of a list of S≥1 CSI resource sets (given by higher layer parameter csi-RS-ResourceSetList), where the list is comprised of references to either or both of NZP CSI-RS resource set(s) and SS/PBCH block set(s) or the list is comprised of references to CSI-IM resource set(s). Each CSI resource setting is located in the DL BWP identified by the higher layer parameter BWP-id, and all CSI resource settings linked to a CSI report setting have the same DL BWP.

As further mentioned above, UE-initiated/event-driven beam reporting may be implemented utilizing a concept according to which a UE notifies beforehand transmission of a beam report.

This may be implemented with periodic UL resources which may be utilized by the terminal/UE for the report such that the terminal/UE only has to indicated beforehand that it intends to transmit a report in the provided UL resources.

However, in such implementation, it is still undefined how both parties know which UL resources are actually (to be) used by the terminal/UE. However, agreement on the UL resources actually (to be) used by the terminal/UE would be advantageous, since otherwise, on the one hand, the network (e.g., gNB has (after the UE notification) to listen on all possible UL resources (periodic UL resources) for whether the terminal/UE has utilized these resources for the report, and on the other hand, all possible UL resources (periodic UL resources) have to be kept free for use by the terminal/UE (i.e., cannot be scheduled for other terminals).

In other words, in such implementation, it is still undefined how the terminal's notification of an intended beam report (i.e., the UL signal used for indicating reporting event) maps or associates to uplink resources used for carrying the report.

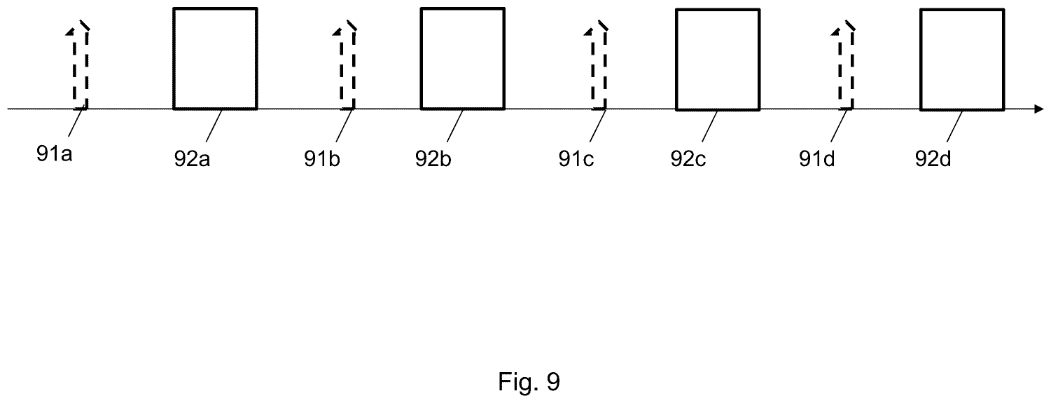

One example scenario is depicted in FIG. 9. FIG. 9 shows a schematic diagram illustrating relationships between uplink resources according to example embodiments, and in particular illustrates an example of reporting resource configuration and UL signaling occasion configuration. As is illustrated in FIG. 9, there may be periodical UL signaling occasions and periodical UL resources, where again, it is still undefined how the terminal's notification of an intended beam report (i.e., the UL signal used for indicating reporting event) maps or associates to uplink resources used for carrying the report.

In FIG. 9, UL signaling occasions (occasions for transmitting the notification, e.g., once reporting necessity is triggered by an event) are indicated with “91” (exemplary 91a, 91b, etc.), and reporting occasions (resources where the actual report might be transmitted) are indicated with “92” (exemplary 92a, 92b, etc.).

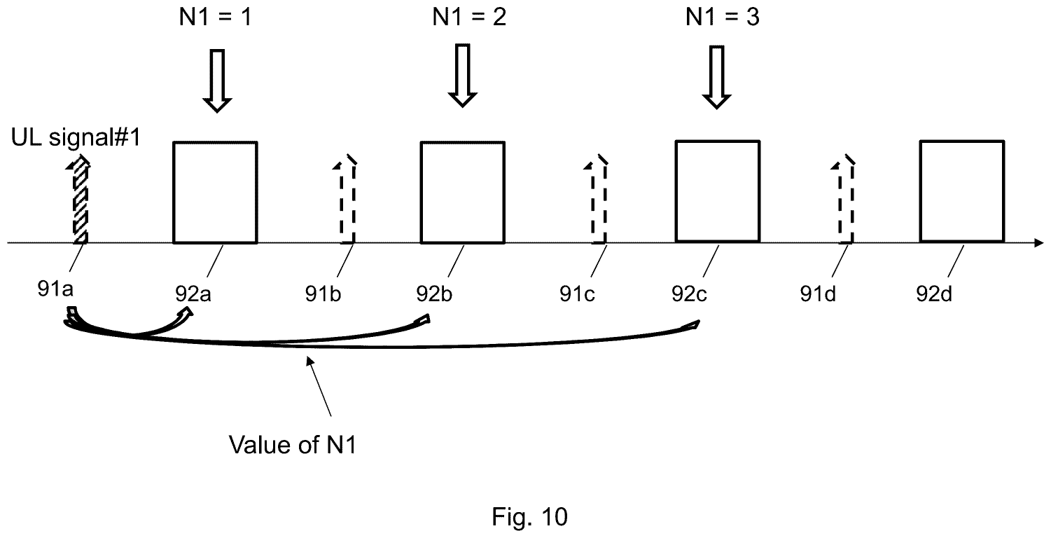

This naming scheme is maintained also for FIG. 10 to FIG. 13.

If no intention to transmit any report is indicated in e.g., signaling occasion 91a, the subsequent reporting occasion resources may be scheduled by the network (e.g., gNB) for other purposes other than terminal-initiated reporting by the considered terminal.

In view of the above, in brief, according to example embodiments, parameters are (at least one parameter is) provided wherein the parameters (the at least one parameter) configure(s) the time domain characteristic between the UL signal indicating the use of UL resource and the reporting UL resource for event triggered reporting.

Namely, according to example embodiments, a parameter (named herein N1 or first parameter) configures the associated reporting occasion in relation with the periodical reporting occasions occurring in relation with the UL signaling occasion.

The value of the first parameter may have values N1=0,1,2,3, . . . (or alternatively N1=1,2,3, . . . ), wherein the first parameter indicates the Nth reporting occasion after (or with respect to) the UL signaling occasion in which the corresponding report is to be transmitted.

FIG. 10 shows a schematic diagram illustrating relationships between uplink resources and possible resource selection results according to example embodiments, and in particular illustrates exemplary associations of UL resources (reporting occasions) with an UL signaling occasion (occasion for transmitting the notification, e.g., once reporting necessity is triggered by an event).

In particular, FIG. 10 schematically illustrates which UL resource (reporting occasion) following an UL signaling occasion (occasion for transmitting the notification, e.g., once reporting necessity is triggered by an event) 91a is associated with the UL signaling occasion (occasion for transmitting the notification, e.g., once reporting necessity is triggered by an event) 91a based on the value of the first parameter N1.

Further, according to example embodiments, a parameter (named herein N2 or second parameter) associated with an UL resource for reporting event triggered information may indicate how many (that may be consecutive) reporting occasions (that may be consecutive reporting occasions) can be/are used for reporting information for the event.

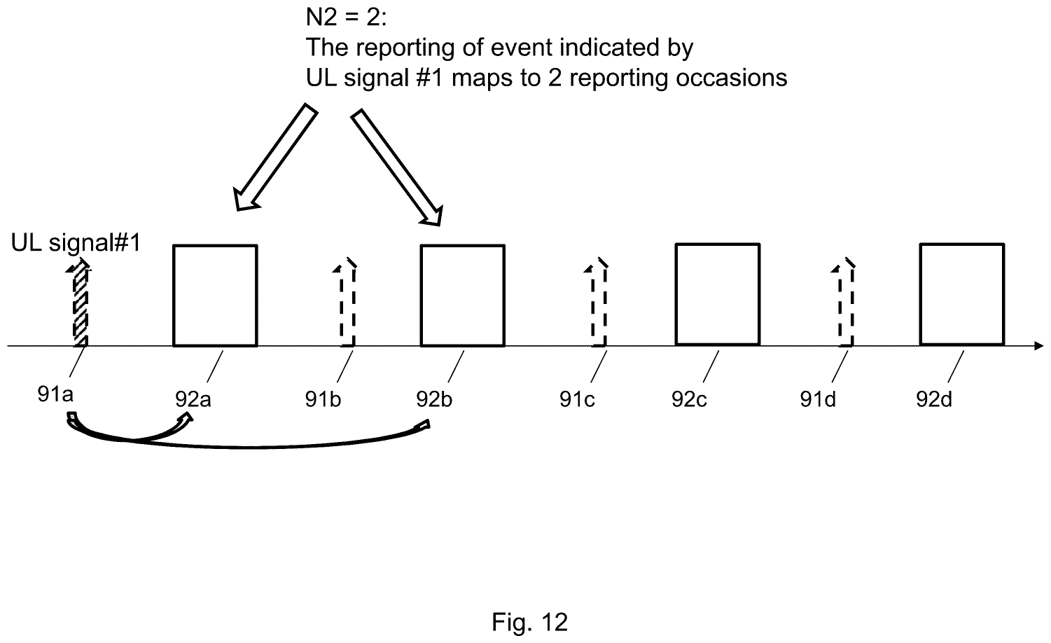

FIG. 12 shows a schematic diagram illustrating relationships between uplink resources and possible resource selection results according to example embodiments, and in particular illustrates exemplary associations of UL resources (reporting occasions) with an UL signaling occasion (occasion for transmitting the notification, e.g., once reporting necessity is triggered by an event).

In particular, FIG. 12 schematically illustrates which UL resources (reporting occasions), namely two (92a, 92b) in the present case of “N2=2”, following an UL signaling occasion (occasion for transmitting the notification, e.g., once reporting necessity is triggered by an event) 91a are associated with the UL signaling occasion (occasion for transmitting the notification, e.g., once reporting necessity is triggered by an event) 91a based on the value of the second parameter N2.

Further, according to example embodiments, a parameter (named herein N3 or third parameter) associated with an UL resource for reporting event-triggered information may indicate a configuration of non-consecutive reporting occasions can/are used for reporting information for the event.

The third parameter may be enriched by (an) additionally provided fourth and/or fifth parameter(s) explained below in detail.

While the parameters are numbered (first parameter, second parameter, . . . , fifth parameter), these parameters are mutually optional, and the numbering thereof is only for distinguishing one from the other. That is, presence or definition or configuration with e.g., the third parameter does not necessitate presence or definition or configuration with e.g., the first parameter and the second parameter.

According to example embodiments, the parameter/parameters is/are configured as part of the reporting configuration. That is, the network (e.g., a gNB) may provide a configuration (which may be a reporting related configuration) to a terminal which includes a configuration of the parameter or parameters. The terminal, with respect to terminal-initiated reporting, may apply/refer to this configuration and in particular the configured parameter(s).

According to further example embodiments, the parameter(s) is/are event specifically configured or applied for all event based reporting configurations. In other words, a parameter configuration for a first event (triggering reporting of e.g., a first metric) may differ from a parameter configuration for a second event (triggering reporting of e.g., a second metric).

Example embodiments are specified below in more detail.

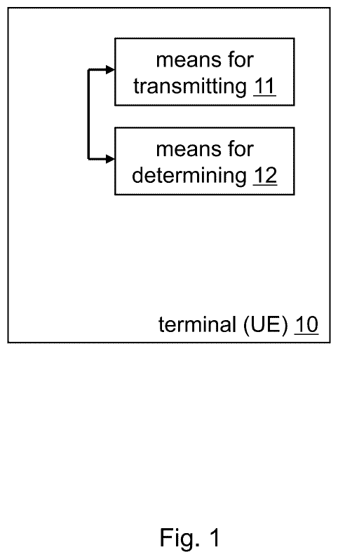

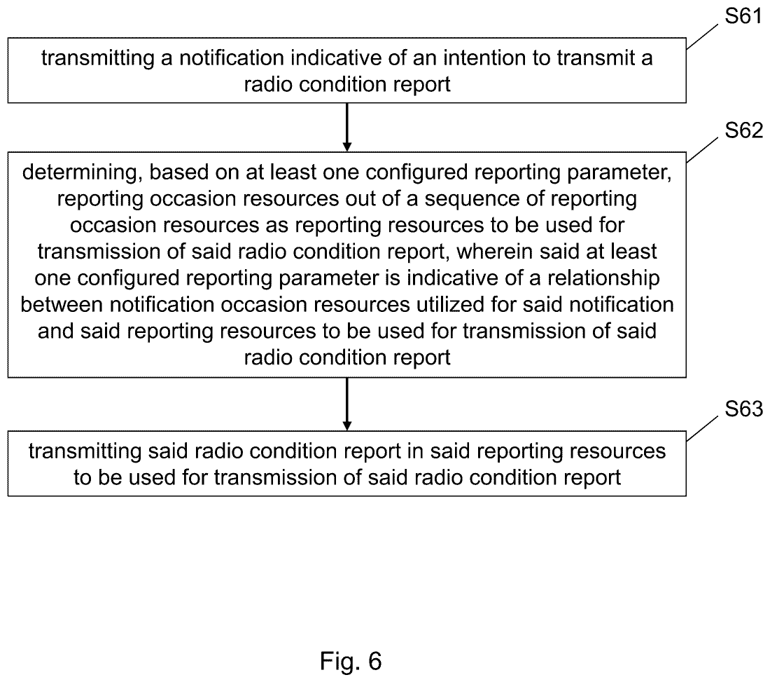

FIG. 1 is a block diagram illustrating an apparatus according to example embodiments. The apparatus may be a terminal 10 such as a user equipment comprising means for transmitting 11 and means for determining 12. The means for transmitting 11 transmits a notification indicative of an intention to transmit a radio condition report. The means for determining 12 determines, based on at least one configured reporting parameter, reporting occasion resources out of a sequence of reporting occasion resources as reporting resources to be used for transmission of said radio condition report. The means for transmitting 11 (or another means for transmitting) transmits said radio condition report in said reporting resources to be used for transmission of said radio condition report. The at least one configured reporting parameter is indicative of a relationship between notification occasion resources utilized for said notification and said reporting resources to be used for transmission of said radio condition report. FIG. 6 is a schematic diagram of a procedure according to example embodiments. The apparatus according to FIG. 1 may perform the method of FIG. 6 but is not limited to this method. The method of FIG. 6 may be performed by the apparatus of FIG. 1 but is not limited to being performed by this apparatus.

As shown in FIG. 6, a procedure according to example embodiments comprises an operation of transmitting (S61) a notification indicative of an intention to transmit a radio condition report, an operation of determining (S62), based on at least one configured reporting parameter, reporting occasion resources out of a sequence of reporting occasion resources as reporting resources to be used for transmission of said radio condition report, and an operation of transmitting (S63) said radio condition report in said reporting resources to be used for transmission of said radio condition report. The at least one configured reporting parameter is indicative of a relationship between notification occasion resources utilized for said notification and said reporting resources to be used for transmission of said radio condition report.

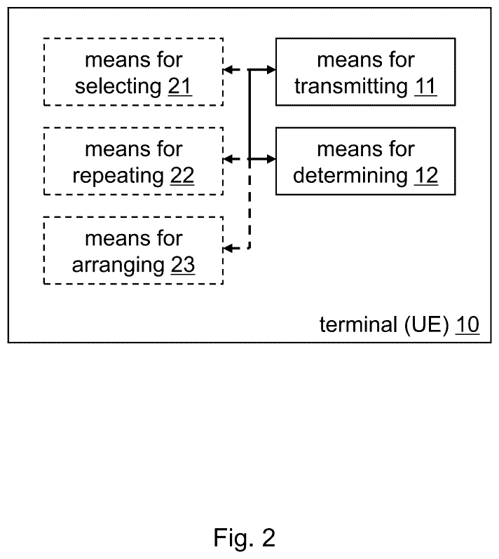

FIG. 2 is a block diagram illustrating an apparatus according to example embodiments. In particular, FIG. 2 illustrates a variation of the apparatus shown in FIG. 1. The apparatus according to FIG. 2 may thus further comprise means for selecting 21, means for repeating 22, and/or means for arranging 23.

In an embodiment at least some of the functionalities of the apparatus shown in FIG. 1 (or 2) may be shared between two physically separate devices forming one operational entity. Therefore, the apparatus may be seen to depict the operational entity comprising one or more physically separate devices for executing at least some of the described processes.

According to further example embodiments, said sequence of reporting occasion resources is a sequence of periodic reporting occasion resources.

According to further example embodiments, said sequence of reporting occasion resources is a sequence of reporting occasion resources occurring after said notification occasion resources utilized for said notification.

According to further example embodiments, said at least one configured reporting parameter is included in a configuration provided by a network access and control entity.

The network access and control entity may for example be a gNB, or in general, the “network side”.

According to further example embodiments, said radio condition report is a measurement report.

According to further example embodiments, said at least one configured reporting parameter includes a first reporting parameter indicative of a sequence position in said sequence of reporting occasion resources.

The first reporting parameter may be named N1 as discussed throughout this document.

According to a variation of the procedure shown in FIG. 6, exemplary additional operations are given, which are inherently independent from each other as such. According to such variation, an exemplary method according to example embodiments may comprise an operation of selecting said first reporting parameter from a configured set of parameter candidates, wherein said notification includes information indicative of said first reporting parameter.

According to a variation of the procedure shown in FIG. 6, exemplary details of the determining operation (S62) are given, which are inherently independent from each other as such. Such exemplary determining operation (S62) according to example embodiments may comprise an operation of

According to a variation of the procedure shown in FIG. 6, exemplary details of the determining operation (S62) are given, which are inherently independent from each other as such. Such exemplary determining operation (S62) according to example embodiments may comprise an operation of selecting reporting occasion resources corresponding to said sequence position in said sequence of reporting occasion resources as said reporting resources to be used for transmission of said radio condition report.

According to a variation of the procedure shown in FIG. 6, exemplary details of the determining operation (S62) are given, which are inherently independent from each other as such. Such exemplary determining operation (S62) according to example embodiments may comprise an operation of selecting at least reporting occasion resources corresponding to a lower sequence position in said sequence of reporting occasion resources lower than said sequence position in said sequence of reporting occasion resources as said reporting resources to be used for transmission of said radio condition report.

According to further example embodiments, said at least one configured reporting parameter includes a second reporting parameter indicative of a reporting occasion resources quantity.

The second reporting parameter may be named N2 as discussed throughout this document.

According to a variation of the procedure shown in FIG. 6, exemplary details of the determining operation (S62) are given, which are inherently independent from each other as such. Such exemplary determining operation (S62) according to example embodiments may comprise an operation of selecting a number of reporting occasion resources corresponding to said reporting occasion resources quantity as said reporting resources to be used for transmission of said radio condition report.

According to a variation of the procedure shown in FIG. 6, exemplary details of the determining operation (S62) are given, which are inherently independent from each other as such. According to such variation, said second reporting parameter is indicative of continuous reporting allowance, and such exemplary determining operation (S62) according to example embodiments may comprise an operation of selecting each of reporting occasion resources out of said sequence of reporting occasion resources as said reporting resources to be used for transmission of said radio condition report until receipt of a continuous reporting disallowance.

According to further example embodiments, said at least one configured reporting parameter includes a third reporting parameter indicative of a reporting occasion resources pattern repetition quantity.

The third reporting parameter may be named N3 as discussed throughout this document.

According to a variation of the procedure shown in FIG. 6, exemplary details of the determining operation (S62) are given, which are inherently independent from each other as such. Such exemplary determining operation (S62) according to example embodiments may comprise an operation of repeating, for a number of times corresponding to said reporting occasion resources pattern repetition quantity, a reporting occasion resources pattern resulting from said determining based on said first reporting parameter and/or said second reporting parameter.

According to a variation of the procedure shown in FIG. 6, exemplary details of the repeating operation are given, which are inherently independent from each other as such. According to such variation, said at least one configured reporting parameter includes a fourth reporting parameter indicative of a reporting occasion resources pattern repetition consecutiveness or reporting occasion resources pattern repetition non-consecutiveness and a fifth reporting parameter indicative of a reporting occasion resources pattern repetition offset, and such exemplary repeating operation according to example embodiments may comprise an operation of arranging, if said fourth reporting parameter is indicative of a reporting occasion resources pattern repetition non-consecutiveness, a subsequent reporting occasion resources pattern at a distance from a preceding reporting occasion resources pattern corresponding to said reporting occasion resources pattern repetition offset.

The fourth reporting parameter may be named N3-non-consecutive as discussed throughout this document. The fifth reporting parameter may be named N3-offset as discussed throughout this document.

According to further example embodiments, a default value of said fifth reporting parameter is set to 1.

According to further example embodiments, said radio condition report is related to a first radio metric or to a second radio metric, and said at least one configured reporting parameter includes a first set of at least one configured reporting parameter valid for reporting related to said first radio metric, and a second set of at least one configured reporting parameter valid for reporting related to said second radio metric.

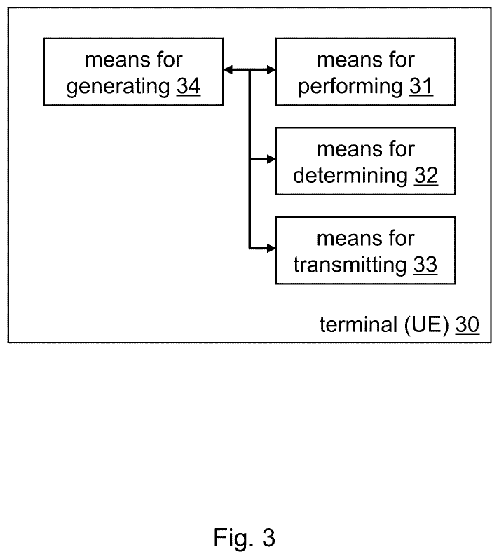

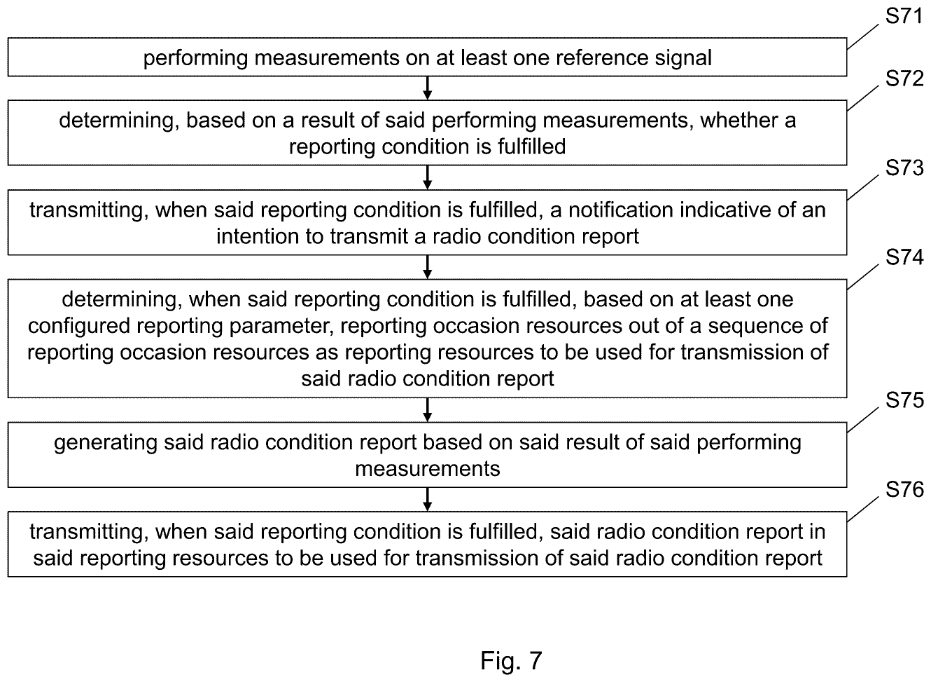

FIG. 3 is a block diagram illustrating an apparatus according to example embodiments. The apparatus may be a terminal 30 such as a user equipment comprising means for performing measurements 31, means for determining 32, means for transmitting 33, and means for generating 34. The means for performing measurements 31 performs measurements on at least one reference signal. The means for determining 32 determines, based on a result of said means for performing measurements, whether a reporting condition is fulfilled. The means for transmitting 33 transmits, when said reporting condition is fulfilled, a notification indicative of an intention to transmit a radio condition report. The means for determining 32 (or another means for determining) determines, when said reporting condition is fulfilled, based on at least one configured reporting parameter, reporting occasion resources out of a sequence of reporting occasion resources as reporting resources to be used for transmission of said radio condition report. The means for generating 34 generates said radio condition report based on said result of said means for performing measurements. The means for transmitting 33 (or another means for transmitting) transmits, when said reporting condition is fulfilled, said radio condition report in said reporting resources to be used for transmission of said radio condition report. FIG. 7 is a schematic diagram of a procedure according to example embodiments. The apparatus according to FIG. 3 may perform the method of FIG. 7 but is not limited to this method. The method of FIG. 7 may be performed by the apparatus of FIG. 3 but is not limited to being performed by this apparatus.

As shown in FIG. 7, a procedure according to example embodiments comprises an operation of performing measurements (S71) on at least one reference signal, an operation of determining (S72), based on a result of said performing measurements, whether a reporting condition is fulfilled, an operation of transmitting (S73), when said reporting condition is fulfilled, a notification indicative of an intention to transmit a radio condition report, an operation of determining (S74), when said reporting condition is fulfilled, based on at least one configured reporting parameter, reporting occasion resources out of a sequence of reporting occasion resources as reporting resources to be used for transmission of said radio condition report, an operation of generating (S75) said radio condition report based on said result of said performing measurements, and an operation of transmitting (S76), when said reporting condition is fulfilled, said radio condition report in said reporting resources to be used for transmission of said radio condition report.

Examples of reporting conditions that may be evaluated as being fulfilled or not (i.e., which is the object or target of the determination in step/operation S72 or of the corresponding means for determining 32) are that
a quality (e.g., L1-RSRP) of a reference signal is worse than a configured threshold, or
a quality of at least one reference signal becomes a threshold value better than certain reference signal (such as reference signal corresponding to the PDCCH reception), or
a quality of a reference signal is better than a certain threshold, or that
a quality of the certain reference signal is worse than a first threshold, and a quality of at least one reference signal is better than a second threshold.

Reporting conditions that may be evaluated as being fulfilled or not are, however, not limited to those mentioned.

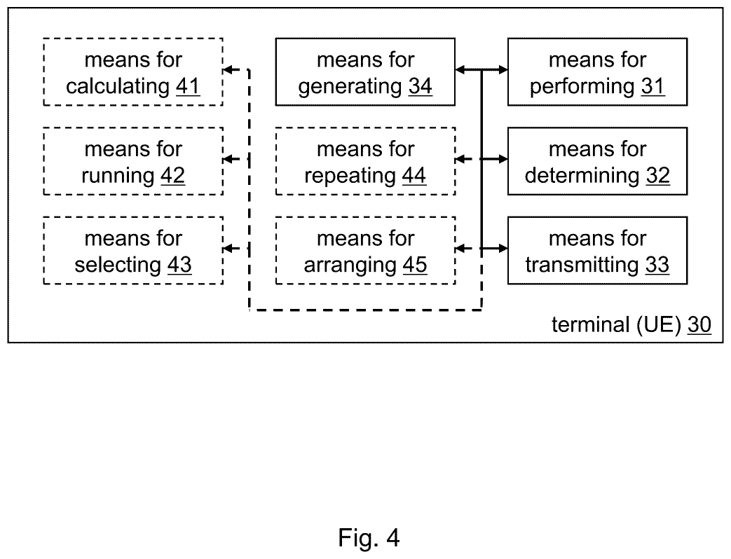

FIG. 4 is a block diagram illustrating an apparatus according to example embodiments. In particular, FIG. 4 illustrates a variation of the apparatus shown in FIG. 3. The apparatus according to FIG. 4 may thus further comprise means for calculating 41, means for running 42, means for selecting 43, means for repeating 44, and/or means for arranging 45.

In an embodiment at least some of the functionalities of the apparatus shown in FIG. 3 (or 4) may be shared between two physically separate devices forming one operational entity. Therefore, the apparatus may be seen to depict the operational entity comprising one or more physically separate devices for executing at least some of the described processes.

According to further example embodiments, said at least one configured reporting parameter is indicative of a relationship between notification occasion resources utilized for said notification and said reporting resources to be used for transmission of said radio condition report.

According to a variation of the procedure shown in FIG. 7, exemplary additional operations are given, which are inherently independent from each other as such. According to such variation, an exemplary method according to example embodiments may comprise an operation of calculating a transmission timing for said radio condition report based on said reporting resources to be used for transmission of said radio condition report.

According to a variation of the procedure shown in FIG. 7, exemplary additional operations are given, which are inherently independent from each other as such. According to such variation, an exemplary method according to example embodiments may comprise an operation of running a timer corresponding to said transmission timing for said radio condition report.

According to a variation of the procedure shown in FIG. 7, exemplary details of the transmitting operation (S76) (transmitting said radio condition report) are given, which are inherently independent from each other as such. Such exemplary determining operation (S76) according to example embodiments may comprise an operation of starting transmitting said radio condition report upon expiry of said timer.

According to further example embodiments, said transmission timing for said radio condition report corresponds to an uplink slot of said reporting resources to be used for transmission of said radio condition report.

According to further example embodiments, said transmission timing for said radio condition report corresponds to an uplink slot a predetermined slot number prior to an uplink slot of said reporting resources to be used for transmission of said radio condition report.

According to further example embodiments, said generating is generating said radio condition report upon expiry of said timer.

According to further example embodiments, said generating is, if a time interval between a transmission of said notification indicative of said intention to transmit said radio condition report and said reporting resources to be used for transmission of said radio condition report is less than a predetermined interval length, generating said radio condition report upon said transmission of said notification indicative of said intention to transmit said radio condition report.

According to further example embodiments, said generating is, if a time interval between a transmission of said notification indicative of said intention to transmit said radio condition report and said reporting resources to be used for transmission of said radio condition report is less than a predetermined interval length, generating said radio condition report prior to said transmission of said notification indicative of said intention to transmit said radio condition report.

According to further example embodiments, said sequence of reporting occasion resources is a sequence of periodic reporting occasion resources.

According to further example embodiments, said sequence of reporting occasion resources is a sequence of reporting occasion resources occurring after said notification occasion resources utilized for said notification.

According to further example embodiments, said at least one configured reporting parameter is included in a configuration provided by a network access and control entity.

According to further example embodiments, said radio condition report is a measurement report.

The network access and control entity may for example be a gNB, or in general, the “network side”.

According to further example embodiments, said at least one configured reporting parameter includes a first reporting parameter indicative of a sequence position in said sequence of reporting occasion resources.

The first reporting parameter may be named N1 as discussed throughout this document.

According to a variation of the procedure shown in FIG. 7, exemplary additional operations are given, which are inherently independent from each other as such. According to such variation, an exemplary method according to example embodiments may comprise an operation of selecting said first reporting parameter from a configured set of parameter candidates, wherein said notification includes information indicative of said first reporting parameter.

According to a variation of the procedure shown in FIG. 7, exemplary details of the determining operation (S74) are given, which are inherently independent from each other as such. Such exemplary determining operation (S74) according to example embodiments may comprise an operation of selecting reporting occasion resources corresponding to said sequence position in said sequence of reporting occasion resources as said reporting resources to be used for transmission of said radio condition report.

According to a variation of the procedure shown in FIG. 7, exemplary details of the determining operation (S74) (determining reporting occasion resources out of a sequence of reporting occasion resources as reporting resources to be used for transmission of said radio condition report) are given, which are inherently independent from each other as such. Such exemplary determining operation (S74) according to example embodiments may comprise an operation of selecting at least reporting occasion resources corresponding to a lower sequence position in said sequence of reporting occasion resources lower than said sequence position in said sequence of reporting occasion resources as said reporting resources to be used for transmission of said radio condition report.

According to further example embodiments, said at least one configured reporting parameter includes a second reporting parameter indicative of a reporting occasion resources quantity.

The second reporting parameter may be named N2 as discussed throughout this document.

According to a variation of the procedure shown in FIG. 7, exemplary details of the determining operation (S74) (determining reporting occasion resources out of a sequence of reporting occasion resources as reporting resources to be used for transmission of said radio condition report) are given, which are inherently independent from each other as such. Such exemplary determining operation (S74) according to example embodiments may comprise an operation of selecting a number of reporting occasion resources corresponding to said reporting occasion resources quantity as said reporting resources to be used for transmission of said radio condition report.

According to a variation of the procedure shown in FIG. 7, exemplary details of the determining operation (S74) (determining reporting occasion resources out of a sequence of reporting occasion resources as reporting resources to be used for transmission of said radio condition report) are given, which are inherently independent from each other as such. According to such variation, said second reporting parameter is indicative of continuous reporting allowance, and such exemplary determining operation (S74) according to example embodiments may comprise an operation of selecting each of reporting occasion resources out of said sequence of reporting occasion resources as said reporting resources to be used for transmission of said radio condition report until receipt of a continuous reporting disallowance.

According to further example embodiments, said at least one configured reporting parameter includes a third reporting parameter indicative of a reporting occasion resources pattern repetition quantity.

The third reporting parameter may be named N3 as discussed throughout this document.

According to a variation of the procedure shown in FIG. 7, exemplary details of the determining operation (S74) (determining reporting occasion resources out of a sequence of reporting occasion resources as reporting resources to be used for transmission of said radio condition report) are given, which are inherently independent from each other as such. Such exemplary determining operation (S74) according to example embodiments may comprise an operation of repeating, for a number of times corresponding to said reporting occasion resources pattern repetition quantity, a reporting occasion resources pattern resulting from said determining based on said first reporting parameter and/or said second reporting parameter.

According to a variation of the procedure shown in FIG. 6, exemplary details of the repeating operation are given, which are inherently independent from each other as such. According to such variation, said at least one configured reporting parameter includes a fourth reporting parameter indicative of a reporting occasion resources pattern repetition consecutiveness or reporting occasion resources pattern repetition non-consecutiveness and a fifth reporting parameter indicative of a reporting occasion resources pattern repetition offset, and such exemplary repeating operation according to example embodiments may comprise an operation of arranging, if said fourth reporting parameter is indicative of a reporting occasion resources pattern repetition non-consecutiveness, a subsequent reporting occasion resources pattern at a distance from a preceding reporting occasion resources pattern corresponding to said reporting occasion resources pattern repetition offset.

The fourth reporting parameter may be named N3-non-consecutive as discussed throughout this document. The fifth reporting parameter may be named N3-offset as discussed throughout this document.

According to further example embodiments, a default value of said fifth reporting parameter is set to 1.

According to further example embodiments, said radio condition report is related to a first radio metric or to a second radio metric, and said at least one configured reporting parameter includes a first set of at least one configured reporting parameter valid for reporting related to said first radio metric, and a second set of at least one configured reporting parameter valid for reporting related to said second radio metric.

According to further example embodiments, said apparatus is operable as or at a terminal, mobile station, modem, or user equipment, such as a smartphone.

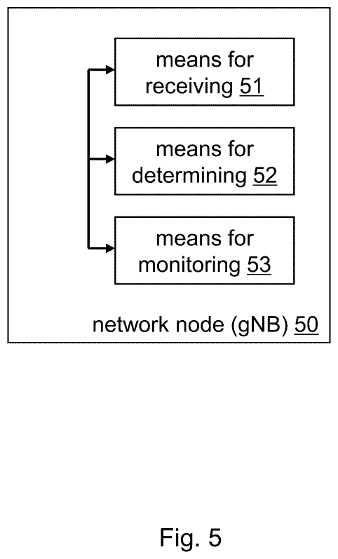

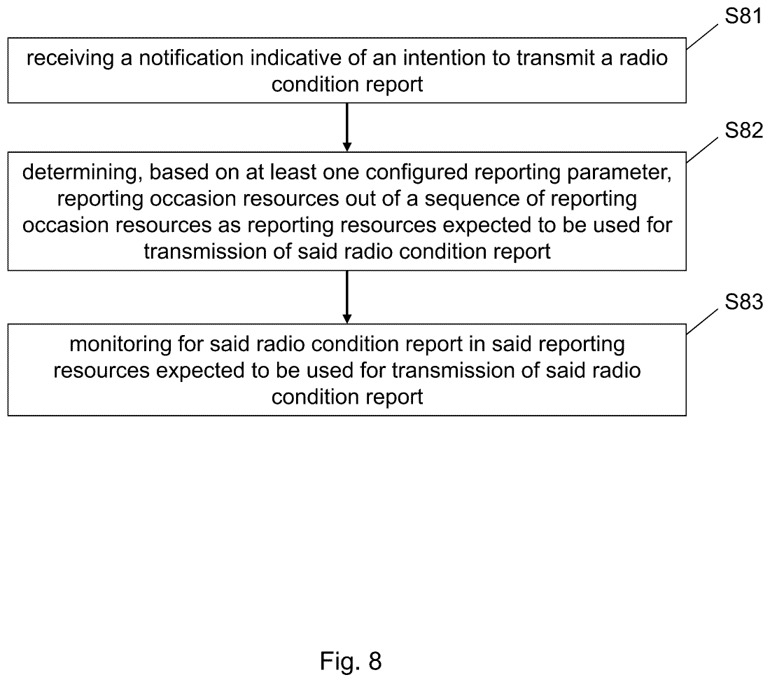

FIG. 5 is a block diagram illustrating an apparatus according to example embodiments. The apparatus may be an access node 50 such as a base station (e.g., a gNB) comprising means for receiving 51, means for determining 52, and means for monitoring 53. The means for receiving 51 receives a notification indicative of an intention to transmit a radio condition report. The means for determining 52 determines, based on at least one configured reporting parameter, reporting occasion resources out of a sequence of reporting occasion resources as reporting resources expected to be used for transmission of said radio condition report. The means for monitoring 53 monitors for said radio condition report in said reporting resources expected to be used for transmission of said radio condition report. FIG. 8 is a schematic diagram of a procedure according to example embodiments. The apparatus according to FIG. 5 may perform the method of FIG. 8 but is not limited to this method. The method of FIG. 8 may be performed by the apparatus of FIG. 5 but is not limited to being performed by this apparatus.

As shown in FIG. 8, a procedure according to example embodiments comprises an operation of receiving (S81) a notification indicative of an intention to transmit a radio condition report, an operation of determining (S82), based on at least one configured reporting parameter, reporting occasion resources out of a sequence of reporting occasion resources as reporting resources expected to be used for transmission of said radio condition report, and an operation of monitoring (S83) for said radio condition report in said reporting resources expected to be used for transmission of said radio condition report.

In an embodiment at least some of the functionalities of the apparatus shown in FIG. 5 may be shared between two physically separate devices forming one operational entity. Therefore, the apparatus may be seen to depict the operational entity comprising one or more physically separate devices for executing at least some of the described processes.

According to further example embodiments, said at least one configured reporting parameter is indicative of a relationship between notification occasion resources utilized for said notification and said reporting resources to be used for transmission of said radio condition report.

Apart from that, the apparatus of FIG. 5 may be seen as counterpart of the apparatus of FIG. 3 or 4. As such, the remaining functionality of the apparatus of FIG. 5 emerges from the description of the apparatus of FIG. 3 or 4 above in such a way that transmissions of the apparatus of FIG. 3 or 4 may terminate at the apparatus of FIG. 5 and be processed at the apparatus of FIG. 5, and that transmissions of the apparatus of FIG. 5 may terminate at the apparatus of FIG. 3 or 4 and be processed at the apparatus of FIG. 3 or 4, and that exchanged information have same characteristics on both sides.

Example embodiments outlined and specified above are explained below in more specific terms.

According to example embodiments, the value N1, i.e., the first parameter, is configured by RRC.

According to further example embodiments, either of the values N1, N2, N3, N3-non-consecutive, and N3-offset, i.e., the first parameter, the second parameter, the third parameter, the first parameter, and the fifth parameter, may be configured by RRC.

According to further example embodiments, the value N1 is determined in implicit manner (i.e., may be dependent on) based on the configured reporting quantity (or metric). As an example, according to example embodiments, it is defined in a specification that a specific quantity such as RSRP is associated with a specific value for N1, while another specific quantity such as signal to noise and interference ratio (SINR) is associated with another specific value for N1.

According to further example embodiments, the value N1 is selected by the terminal/UE (e.g., from a (radio resource control (RRC)) configured set of candidate values), wherein the N1 is indicated by the UL signal indicating the use of reporting occasion (i.e., reporting event has been triggered).

According to example embodiments, the value N1 indicates the reporting occasion the UE is configured to provision the event triggered report, which is explained above with respect to FIG. 10.

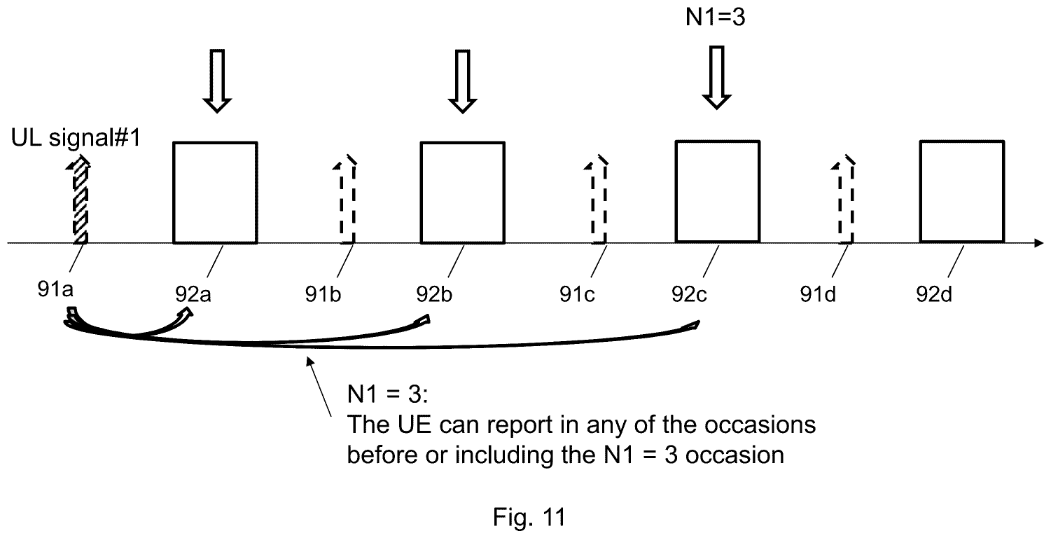

Alternatively, according to example embodiments, the value N1 indicates the last reporting occasion the UE is configured to provision the event triggered report. This is illustrated in FIG. 11.

FIG. 11 shows a schematic diagram illustrating relationships between uplink resources and possible resource selection results according to example embodiments, and in particular illustrates exemplary associations of UL resources (reporting occasions) with an UL signaling occasion (occasion for transmitting the notification, e.g., once reporting necessity is triggered by an event).

In particular, FIG. 11 schematically illustrates which UL resource (reporting occasion) 92c following an UL signaling occasion (occasion for transmitting the notification, e.g., once reporting necessity is triggered by an event) 91a is the last UL resource (reporting occasion) associated with the UL signaling occasion (occasion for transmitting the notification, e.g., once reporting necessity is triggered by an event) 91a based on the value of the first parameter N1.

Namely, as an example, with value N1=1, the last reporting occasion is the same as the first reporting occasion associated with the indication.

Further, as an example, with value N1=3 (as illustrated in FIG. 11), the last reporting occasion is the third reporting occasion associated with the indication. The UE may report in any of the valid reporting occasions before or including the last reporting occasion. e.g., N1=1 or N1=2 or N1=3.

Hence, as a generalized example, with value N1=M, the last reporting occasion is the Mth reporting occasion associated with the indication. The UE may report in any of the valid reporting occasions before or including the last (Mth) reporting occasion.

According to example embodiments, the value of N1 is expressed in symbols/slots subject to configured numerology with respect to the transmission occasion of UL signal/reference signal.

According to example embodiments, the value N1 is defined so that the default/first/first valid reporting occasions is the Nth reporting occasion.

According to example embodiments, the value N2, i.e., the second parameter, ranges from 1,2,3,4, . . .

According to further example embodiments, the value N2 configures the number of reporting occasions the UE is configured to report information once the reporting is triggered.

Namely, as an example, N2=1 means that the UE reports on the one associated reporting occasion.

Further, as an example, N2=2 means that the UE reports on the two (consecutive) occasions starting for the first associated reporting occasion.

According to further example embodiments, a specific one of the values of N2 is specified to configure the UE to report on reporting occasions (e.g., continuously) until the reporting is cancelled by the network using a downlink control signaling (e.g., DCI indication).

According to further example embodiments, the value N2 configures the number of reporting occasions associated with the reporting configuration so that up to N2 number of occasions correspond to the single reporting instance.

According to further example embodiments, the value of N3, i.e., the third parameter, has values e.g., 1,2,3, . . . , respectively defining repetition of triggered event reporting over N3 different transmission occasions.

When the UE is configured with N3=N2, according to example embodiments, the UE is indicated to repeat transmission of triggered event report over N2 consecutive reporting occasions.

According to further example embodiments, the UE may be configured additionally with higher layer parameter N3-non-consecutive, i.e., the fourth parameter, and N3-offset, i.e., the fifth parameter, where N3-non-consecutive is defined as a Boolean value with ‘0=consecutive’/‘1=non-consecutive’ meaning, and the N3-offset indicates an offset between transmission occasions of event triggered reporting.

For example, when the UE is configured with N2=4, N3=2, N3-non-consecutive=1, and N3-offset=1, the UE shall repeat transmission of event triggered reporting over two non-consecutive transmission occasions of the report over N2 reporting occasions.

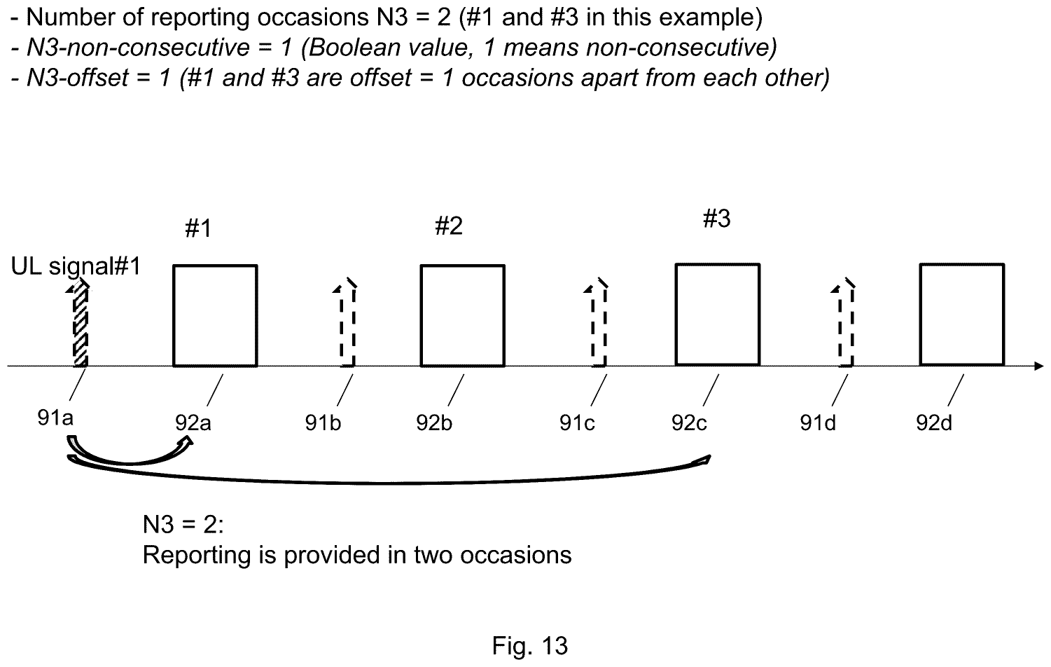

A result of such determination of UL resources is shown in FIG. 13. FIG. 13 shows a schematic diagram illustrating relationships between uplink resources and possible resource selection results according to example embodiments, and in particular illustrates exemplary associations of UL resources (reporting occasions) with an UL signaling occasion (occasion for transmitting the notification, e.g., once reporting necessity is triggered by an event).

In particular, FIG. 13 schematically illustrates which UL resources (reporting occasion) 92a, 92c following an UL signaling occasion (occasion for transmitting the notification, e.g., once reporting necessity is triggered by an event) 91a are the UL resources (reporting occasions) associated with the UL signaling occasion (occasion for transmitting the notification, e.g., once reporting necessity is triggered by an event) 91a based on the values of the third to fifth parameters (N3=2, N3-non-consecutive=1, and N3-offset=1).

According to further example embodiments, the combination of parameters N2 and N3, where N2>N3 and condition modulo (N2,N3)=0 is fulfilled, implicitly indicates repetition of event triggered report over non-consecutive transmission occasions defined by N2. When the UE is not configured with parameter N3-offset, the UE shall assume offset to be 1. For example, when N2=4 and N3=2, the condition N2>N3 and modulo (4,2)=0 is fulfilled, and thus the UE shall repeat transmission of event triggered reporting over two non-consecutive transmission occasions of the report over four reporting occasions.

According to further example embodiments, the terminal/UE performs measurements on at least one reference signal or a set of signals to determine if at least one reporting condition is fulfilled. Upon determining that the (at least one) reporting conditions is fulfilled, the terminal/UE determines to indicate the event (to network) by triggering a transmission of at least one indication/notification.

According to further example embodiments, a reporting condition/event that may be evaluated by the UE may refer to one or more of following (but is not limited to these):
first exemplary event: a quality (e.g., L1-RSRP) of a reference signal is worse than a configured threshold;
second exemplary event: a quality of at least one reference signal becomes a threshold value better than certain reference signal (such as reference signal corresponding to the PDCCH reception);
third exemplary event: a quality of a reference signal is better than a certain threshold;
fourth exemplary event: a quality of the certain reference signal is worse than a threshold 1, and quality of at least one reference signal is better than a (another) threshold 2.

According to further example embodiments, the terminal/UE, upon triggering the indication, further determines the timeline/time value associated with the triggered signal. The time value is determined based at least on one value configured in the triggered reporting (configuration), and the time value is calculated based on the periodic availability of the uplink reporting resource.

According to further example embodiments, the terminal/UE reports the event triggered report on the determined UL slot.

According to further example embodiments, the terminal/UE starts a timer that corresponds to the value determined by the UE upon triggering the UL signal.

According to further example embodiments, the terminal/UE, upon expiry of the timer, reports on the UL resource associated with the UL signal indicating the event.

According to further example embodiments, the timer length is configured such that it corresponds to the uplink slot in which the reporting is configured.

According to further example embodiments, the timer length is configured such that it corresponds to a slot Nx slot(s) prior to the uplink slot in which the reporting is configured, wherein upon expiry of the timer the terminal/UE prepares/computes/calculates the event triggered report.

According to further example embodiments, if the time interval between the UL signal and UL resource is less than X milliseconds/slots/symbols (i.e., a predetermined interval), the terminal/UE prepares the report upon triggering the UL signal.

According to further example embodiments, if the time interval between the UL signal and UL resource is less than X milliseconds/slots/symbols (i.e., a predetermined interval), the terminal/UE prepares the report prior to the triggering of the UL signal.

As a result, according to example embodiments, advantageously, scheduling flexibility/configuration flexibility is enabled for the network, such that, consequently, waste of UL resources can be avoided, but also control/coordination signaling can be reduced.

The above-described procedures and functions may be implemented by respective functional elements, processors, or the like, as described below.

In the foregoing exemplary description of the network entity, only the units that are relevant for understanding the principles of the disclosure have been described using functional blocks. The network entity may comprise further units that are necessary for its respective operation. However, a description of these units is omitted in this specification. The arrangement of the functional blocks of the devices is not construed to limit the disclosure, and the functions may be performed by one block or further split into sub-blocks.

When in the foregoing description it is stated that the apparatus, i.e., network entity (or some other means) is configured to perform some function, this is to be construed to be equivalent to a description stating that a (i.e., at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e., the expression “unit/circuitry configured to” is construed to be equivalent to an expression such as “means for”).

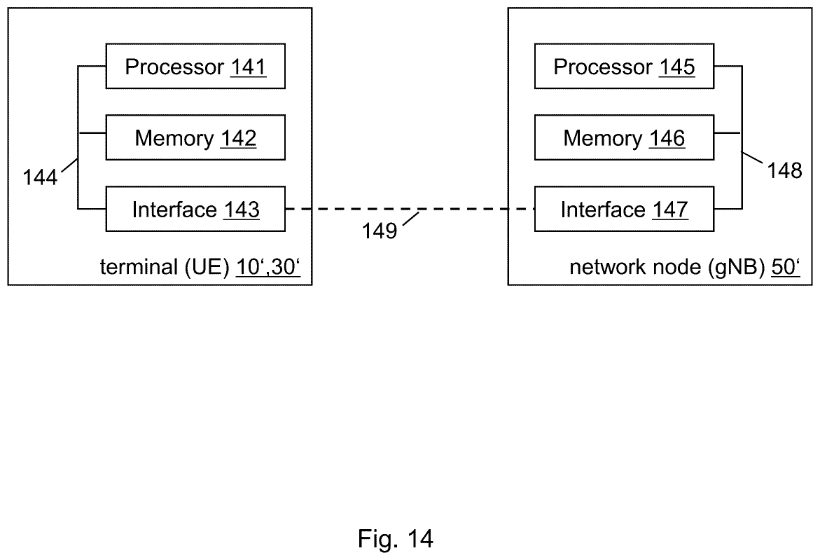

In FIG. 14, an alternative illustration of apparatuses according to example embodiments is depicted. As indicated in FIG. 14, according to example embodiments, the apparatus (terminal) 10′, 30′ (corresponding to the terminal 10, 30) comprises a processor 141, a memory 142 and an interface 143, which are connected by a bus 144 or the like. Further, according to example embodiments, the apparatus (network node) 50′ (corresponding to the network node 50) comprises a processor 145, a memory 146 and an interface 147, which are connected by a bus 148 or the like, and the apparatuses may be connected via link 149, respectively.

The processor 141/145 and/or the interface 143/147 may also include a modem or the like to facilitate communication over a (hardwire or wireless) link, respectively. The interface 143/147 may include a suitable transceiver coupled to one or more antennas or communication means for (hardwire or wireless) communications with the linked or connected device(s), respectively. The interface 143/147 is generally configured to communicate with at least one other apparatus, i.e., the interface thereof.

The memory 142/146 may store respective programs assumed to include program instructions or computer program code that, when executed by the respective processor, enables the respective electronic device or apparatus to operate in accordance with the example embodiments.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e., the expression “processor configured to [cause the apparatus to] perform xxx-ing” is construed to be equivalent to an expression such as “means for xxx-ing”). Also, such function is to be construed to be equivalently implementable by specifically configured circuitry configured to perform the respective function (i.e., the expression “processor configured to [cause the apparatus to] perform xxx-ing” is construed to be equivalent to an expression such as “xxx-ing circuitry configured to xxx”).

According to example embodiments, an apparatus representing the terminal 10 comprises at least one processor 141, at least one memory 142 including computer program code, and at least one interface 143 configured for communication with at least another apparatus. The processor (i.e., the at least one processor 141, with the at least one memory 142 and the computer program code) is configured to perform transmitting a notification indicative of an intention to transmit a radio condition report (thus the apparatus comprising corresponding transmitting circuitry configured to transmit), to perform determining, based on at least one configured reporting parameter, reporting occasion resources out of a sequence of reporting occasion resources as reporting resources to be used for transmission of said radio condition report (wherein said at least one configured reporting parameter is indicative of a relationship between notification occasion resources utilized for said notification and said reporting resources expected to be used for transmission of said radio condition report) (thus the apparatus comprising corresponding determining circuitry configured to determine), and to perform transmitting said radio condition report in said reporting resources to be used for transmission of said radio condition report.

According to example embodiments, an apparatus representing the terminal 30 comprises at least one processor 141, at least one memory 142 including computer program code, and at least one interface 143 configured for communication with at least another apparatus. The processor (i.e., the at least one processor 141, with the at least one memory 142 and the computer program code) is configured to perform performing measurements on at least one reference signal (thus the apparatus comprising corresponding measuring circuitry configured to perform measurements), to perform determining, based on a result of said performing measurements, whether a reporting condition is fulfilled (thus the apparatus comprising corresponding determining circuitry configured to determine), to perform transmitting, when said reporting condition is fulfilled, a notification indicative of an intention to transmit a radio condition report (thus the apparatus comprising corresponding transmitting circuitry configured to transmit), to perform determining, when said reporting condition is fulfilled, based on at least one configured reporting parameter, reporting occasion resources out of a sequence of reporting occasion resources as reporting resources to be used for transmission of said radio condition report (wherein said at least one configured reporting parameter may be indicative of a relationship between notification occasion resources utilized for said notification and said reporting resources expected to be used for transmission of said radio condition report), to perform generating said radio condition report based on said result of said performing measurements (thus the apparatus comprising corresponding generating circuitry configured to generate), and to perform transmitting, when said reporting condition is fulfilled, said radio condition report in said reporting resources to be used for transmission of said radio condition report.

According to example embodiments, an apparatus representing the network node 50 comprises at least one processor 145, at least one memory 146 including computer program code, and at least one interface 147 configured for communication with at least another apparatus. The processor (i.e., the at least one processor 145, with the at least one memory 146 and the computer program code) is configured to perform receiving a notification indicative of an intention to transmit a radio condition report (thus the apparatus comprising corresponding receiving circuitry configured to receive), to perform determining, based on at least one configured reporting parameter, reporting occasion resources out of a sequence of reporting occasion resources as reporting resources expected to be used for transmission of said radio condition report (wherein said at least one configured reporting parameter may be indicative of a relationship between notification occasion resources utilized for said notification and said reporting resources expected to be used for transmission of said radio condition report) (thus the apparatus comprising corresponding determining circuitry configured to determine), and to perform monitoring for said radio condition report in said reporting resources expected to be used for transmission of said radio condition report (thus the apparatus comprising corresponding monitoring circuitry configured to monitor).

For further details regarding the operability/functionality of the individual apparatuses, reference is made to the above description in connection with any one of FIGS. 1 to 13, respectively.

For the purpose of the present disclosure as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g., the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present disclosure. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

In view of the above, there are provided measures for coordination of terminal-initiated reporting. Such measures exemplarily comprise performing measurements on at least one reference signal, determining, based on a result of said performing measurements, whether a reporting condition is fulfilled, transmitting, when said reporting condition is fulfilled, a notification indicative of an intention to transmit a radio condition report, determining, when said reporting condition is fulfilled, based on at least one configured reporting parameter, reporting occasion resources out of a sequence of reporting occasion resources as reporting resources to be used for transmission of said radio condition report, generating said radio condition report based on said result of said performing measurements, and transmitting, when said reporting condition is fulfilled, said radio condition report in said reporting resources to be used for transmission of said radio condition report.

Even though the disclosure is described above with reference to the examples according to the accompanying drawings, it is to be understood that the disclosure is not restricted thereto. Rather, it is apparent to those skilled in the art that the present disclosure can be modified in many ways without departing from the scope of the inventive idea as disclosed herein.

Among others, the following Items are covered by the above disclosure:
Item 1. An apparatus, comprising
   at least one processor, and
   at least one memory storing instructions that, when executed by the at least one processor, cause the apparatus at least to perform:
      performing measurements on at least one reference signal,
      determining, based on a result of said performing measurements, whether a reporting condition is fulfilled,
      transmitting, when said reporting condition is fulfilled, a notification indicative of an intention to transmit a radio condition report,
      determining, when said reporting condition is fulfilled, based on at least one configured reporting parameter, reporting occasion resources out of a sequence of reporting occasion resources as reporting resources to be used for transmission of said radio condition report,
      generating said radio condition report based on said result of said performing measurements, and
      transmitting, when said reporting condition is fulfilled, said radio condition report in said reporting resources to be used for transmission of said radio condition report.
Item 2. The apparatus according to Item 1, wherein
   said at least one configured reporting parameter is indicative of a relationship between notification occasion resources utilized for said notification and said reporting resources to be used for transmission of said radio condition report.
Item 3. The apparatus according to Item 1 or 2, wherein
   said sequence of reporting occasion resources is a sequence of periodic reporting occasion resources.
Item 4. The apparatus according to any of Items 1 to 3, wherein
   said sequence of reporting occasion resources is a sequence of reporting occasion resources occurring after said notification occasion resources utilized for said notification.
Item 5. The apparatus according to any of Items 1 to 4, wherein
   said at least one configured reporting parameter is included in a configuration provided by a network access and control entity.
Item 6. The apparatus according to any of Items 1 to 5, wherein
   said radio condition report is a measurement report.
Item 7. The apparatus according to any of Items 1 to 6, wherein
   said at least one configured reporting parameter includes a first reporting parameter indicative of a sequence position in said sequence of reporting occasion resources.
Item 8. The apparatus according to Item 7, wherein
   the instructions, when executed by the at least one processor, cause the apparatus at least to perform:
      selecting said first reporting parameter from a configured set of parameter candidates, wherein
   said notification includes information indicative of said first reporting parameter.
Item 9. The apparatus according to Item 7 or 8, wherein
   in relation to said determining, the instructions, when executed by the at least one processor, cause the apparatus at least to perform:
      selecting reporting occasion resources corresponding to said sequence position in said sequence of reporting occasion resources as said reporting resources to be used for transmission of said radio condition report.
Item 10. The apparatus according to Item 7 or 8, wherein
   in relation to said determining, the instructions, when executed by the at least one processor, cause the apparatus at least to perform:
      selecting at least reporting occasion resources corresponding to a lower sequence position in said sequence of reporting occasion resources lower than said sequence position in said sequence of reporting occasion resources as said reporting resources to be used for transmission of said radio condition report.
Item 11. The apparatus according to any of Items 1 to 10, wherein
   said at least one configured reporting parameter includes a second reporting parameter indicative of a reporting occasion resources quantity.
Item 12. The apparatus according to Item 11, wherein
   in relation to said determining, the instructions, when executed by the at least one processor, cause the apparatus at least to perform:
      selecting a number of reporting occasion resources corresponding to said reporting occasion resources quantity as said reporting resources to be used for transmission of said radio condition report.
Item 13. The apparatus according to Item 11 or 12, wherein
   said second reporting parameter is indicative of continuous reporting allowance, and
   in relation to said determining, the instructions, when executed by the at least one processor, cause the apparatus at least to perform:
      selecting each of reporting occasion resources out of said sequence of reporting occasion resources as said reporting resources to be used for transmission of said radio condition report until receipt of a continuous reporting disallowance.
Item 14. The apparatus according to any of Items 7 to 13, wherein
   said at least one configured reporting parameter includes a third reporting parameter indicative of a reporting occasion resources pattern repetition quantity.
Item 15. The apparatus according to Item 14, wherein
   in relation to said determining, the instructions, when executed by the at least one processor, cause the apparatus at least to perform:
      repeating, for a number of times corresponding to said reporting occasion resources pattern repetition quantity, a reporting occasion resources pattern resulting from said determining based on said first reporting parameter and/or said second reporting parameter.
Item 16. The apparatus according to Item 15, wherein
   said at least one configured reporting parameter includes a fourth reporting parameter indicative of a reporting occasion resources pattern repetition consecutiveness or reporting occasion resources pattern repetition non-consecutiveness and a fifth reporting parameter indicative of a reporting occasion resources pattern repetition offset, wherein
   in relation to said repeating, the instructions, when executed by the at least one processor, cause the apparatus at least to perform:
      arranging, if said fourth reporting parameter is indicative of a reporting occasion resources pattern repetition non-consecutiveness, a subsequent reporting occasion resources pattern at a distance from a preceding reporting occasion resources pattern corresponding to said reporting occasion resources pattern repetition offset.
Item 17. The apparatus according to Item 16, wherein
   a default value of said fifth reporting parameter is set to 1.
Item 18. The apparatus according to any of Items 1 to 17, wherein
   said radio condition report is related to a first radio metric or to a second radio metric, and
   said at least one configured reporting parameter includes
      a first set of at least one configured reporting parameter valid for reporting related to said first radio metric, and
      a second set of at least one configured reporting parameter valid for reporting related to said second radio metric.
Item 19. The apparatus according to any of Items 1 to 18, wherein
   said apparatus is operable as or at a terminal, mobile station, modem, or user equipment, such as a smartphone.
Item 20. A method, comprising
   performing measurements on at least one reference signal,
   determining, based on a result of said performing measurements, whether a reporting condition is fulfilled,
   transmitting, when said reporting condition is fulfilled, a notification indicative of an intention to transmit a radio condition report,
   determining, when said reporting condition is fulfilled, based on at least one configured reporting parameter, reporting occasion resources out of a sequence of reporting occasion resources as reporting resources to be used for transmission of said radio condition report,
   generating said radio condition report based on said result of said performing measurements, and
   transmitting, when said reporting condition is fulfilled, said radio condition report in said reporting resources to be used for transmission of said radio condition report.
Item 21. A computer program comprising instructions which, when the program is executed by a computer, cause the computer to carry out:
   performing measurements on at least one reference signal,
   determining, based on a result of said performing measurements, whether a reporting condition is fulfilled,
   transmitting, when said reporting condition is fulfilled, a notification indicative of an intention to transmit a radio condition report,
   determining, when said reporting condition is fulfilled, based on at least one configured reporting parameter, reporting occasion resources out of a sequence of reporting occasion resources as reporting resources to be used for transmission of said radio condition report,
   generating said radio condition report based on said result of said performing measurements, and
   transmitting, when said reporting condition is fulfilled, said radio condition report in said reporting resources to be used for transmission of said radio condition report.
Item 22. An apparatus, comprising
   at least one processor, and
   at least one memory storing instructions that, when executed by the at least one processor, cause the apparatus at least to perform:
      receiving a notification indicative of an intention to transmit a radio condition report,
      determining, based on at least one configured reporting parameter, reporting occasion resources out of a sequence of reporting occasion resources as reporting resources expected to be used for transmission of said radio condition report, and
      monitoring for said radio condition report in said reporting resources expected to be used for transmission of said radio condition report.
Item 23. The apparatus according to Item 22, wherein
   said at least one configured reporting parameter is indicative of a relationship between notification occasion resources utilized for said notification and said reporting resources to be used for transmission of said radio condition report.
Item 24. A method, comprising
   receiving a notification indicative of an intention to transmit a radio condition report,
   determining, based on at least one configured reporting parameter, reporting occasion resources out of a sequence of reporting occasion resources as reporting resources expected to be used for transmission of said radio condition report, and
   monitoring for said radio condition report in said reporting resources expected to be used for transmission of said radio condition report.
Item 25. A computer program comprising instructions which, when the program is executed by a computer, cause the computer to carry out:
   receiving a notification indicative of an intention to transmit a radio condition report,
   determining, based on at least one configured reporting parameter, reporting occasion resources out of a sequence of reporting occasion resources as reporting resources expected to be used for transmission of said radio condition report, and
   monitoring for said radio condition report in said reporting resources expected to be used for transmission of said radio condition report.

### LIST OF ACRONYMS AND ABBREVIATIONS

3GPP 3rd Generation Partnership Project
BM beam management
BWP bandwidth part
CQI channel quality indicator
CRI CSI-RS resource indicator
CSI channel state information
DCI downlink control information
DL downlink
PUSCH Physical Uplink Shared Channel
FR2 frequency range 2
L1 layer 1
LI layer indicator
MAC-CE medium access control control element
MIMO multiple input multiple output
PMI precoding matrix indicator
RI rank indicator
RS reference signal
RSRP reference signal received power
RSRQ reference signal received quality
SINR signal to noise and interference ratio
SSBRI SS/PBCH block resource indicator
sTRP single transmission/reception point
TDCP time-domain channel properties
UCI uplink control information
UE user equipment
UL uplink

1. An apparatus comprising:
at least one processor; and
at least one memory storing instructions that when executed by the at least one processor, cause the apparatus at least to perform:
performing measurements on at least one reference signal,
determining, based on a result of the performing measurements, whether a reporting condition is fulfilled,
transmitting, when the reporting condition is fulfilled, a notification indicative of an intention to transmit a radio condition report,
determining, when the reporting condition is fulfilled, based on at least one configured reporting parameter, reporting occasion resources out of a sequence of reporting occasion resources as reporting resources to be used for transmission of the radio condition report,
generating the radio condition report based on the result of the performing measurements, and
transmitting, when the reporting condition is fulfilled, the radio condition report in the reporting resources to be used for transmission of said radio condition report.

2. The apparatus according to claim 1, wherein:
the at least one configured reporting parameter is indicative of a relationship between notification occasion resources utilized for the notification and the reporting resources to be used for transmission of the radio condition report.

3. The apparatus according to claim 1, wherein:
the sequence of reporting occasion resources is a sequence of periodic reporting occasion resources.

4. The apparatus according to claim 1, wherein:
the sequence of reporting occasion resources is a sequence of reporting occasion resources occurring after the notification occasion resources utilized for the notification.

5. The apparatus according to claim 1, wherein:
the at least one configured reporting parameter is included in a configuration provided by a network access and control entity.

6. The apparatus according to claim 1, wherein:
the radio condition report is a measurement report.

7. The apparatus according to claim 1, wherein:
the at least one configured reporting parameter includes a first reporting parameter indicative of a sequence position in the sequence of reporting occasion resources.

8. The apparatus according to claim 7, wherein the apparatus is further caused to perform:
selecting the first reporting parameter from a configured set of parameter candidates, wherein:
the notification includes information indicative of said first reporting parameter.

9. The apparatus according to claim 7, wherein:
the determining the reporting occasion resources comprises:
selecting the reporting occasion resources corresponding to the sequence position in the sequence of reporting occasion resources as the reporting resources to be used for transmission of the radio condition report.

10. The apparatus according to claim 7, wherein:
the determining the reporting occasion resources comprises:
selecting at least reporting occasion resources corresponding to a lower sequence position in the sequence of reporting occasion resources lower than the sequence position in the sequence of reporting occasion resources as the reporting resources to be used for transmission of the radio condition report.

11. The apparatus according to claim 1, wherein:
the at least one configured reporting parameter includes a second reporting parameter indicative of a reporting occasion resources quantity.

12. The apparatus according to claim 11, wherein:
the determining the reporting occasion resources comprises:
selecting a number of reporting occasion resources corresponding to the reporting occasion resources quantity as the reporting resources to be used for transmission of the radio condition report.

13. The apparatus according to claim 11, wherein:
the second reporting parameter is indicative of continuous reporting allowance, and
the determining the reporting occasion resources comprises:
the selecting each of reporting occasion resources out of the sequence of reporting occasion resources as the reporting resources to be used for transmission of the radio condition report until receipt of a continuous reporting disallowance.

14. The apparatus according to claim 7, wherein:
the at least one configured reporting parameter includes a third reporting parameter indicative of a reporting occasion resources pattern repetition quantity.

15. The apparatus according to claim 14, wherein:
the determining the reporting occasion resources comprises:
repeating, for a number of times corresponding to the reporting occasion resources pattern repetition quantity, a reporting occasion resources pattern based on the first reporting parameter and/or the second reporting parameter.

16. The apparatus according to claim 15, wherein:
the at least one configured reporting parameter includes a fourth reporting parameter indicative of a reporting occasion resources pattern repetition consecutiveness or reporting occasion resources pattern repetition non-consecutiveness and a fifth reporting parameter indicative of a reporting occasion resources pattern repetition offset,
wherein the repeating comprises:
arranging, if the fourth reporting parameter is indicative of a reporting occasion resources pattern repetition non-consecutiveness, a subsequent reporting occasion resources pattern at a distance from a preceding reporting occasion resources pattern corresponding to the reporting occasion resources pattern repetition offset.

17. The apparatus according to claim 16, wherein:
a default value of the fifth reporting parameter is set to 1.

18. The apparatus according to claim 1, wherein:
the radio condition report is related to a first radio metric or to a second radio metric, and
the at least one configured reporting parameter includes:
a first set of at least one configured reporting parameter valid for reporting related to the first radio metric, and
a second set of at least one configured reporting parameter valid for reporting related to the second radio metric.

19. The apparatus according to claim 1, wherein:
the apparatus is operable as or at a terminal, mobile station, modem, or user equipment.

20. A method, comprising:
performing measurements on at least one reference signal,
determining, based on a result of said performing measurements, whether a reporting condition is fulfilled,
transmitting, when the reporting condition is fulfilled, a notification indicative of an intention to transmit a radio condition report,
determining, when the reporting condition is fulfilled, based on at least one configured reporting parameter, reporting occasion resources out of a sequence of reporting occasion resources as reporting resources to be used for transmission of the radio condition report,
generating the radio condition report based on the result of the performing measurements, and
transmitting, when the reporting condition is fulfilled, the radio condition report in the reporting resources to be used for transmission of the radio condition report.
